(19) United States
(12) Patent Application Publication
(10) Pub. No.: US 2008/0034856 A1
(43) Pub. Date: Feb. 14, 2008

(54) Reduced-length measure while drilling apparatus using electric field short range data transmission

(75) Inventors: Donald H. Van Steenwyk, Paso Robles, CA (US); Dennis J. Buckley, Paso Robles, CA (US); James R. Higginbotham, The Woodlands, TX (US)

Correspondence Address: WILLIAM W. HAEFLIGER, 201 S. LAKE AVE, SUITE 512, PASADENA, CA, 91101, US

(73) Assignee: Scientific Drilling International

(21) Appl. No.: 11/820,790

(22) Filed: Jun. 21, 2007

Related U.S. Application Data
(60) Provisional application No. 60/836,486, filed on Aug. 8, 2006.

(51) Int. Cl. E21B 44/00; G08C 19/06

(52) U.S. Cl. 73/152.46; 340/870.31

(57) ABSTRACT

A down hole apparatus for measure while drilling usage comprising, in combination, a housing including one or more housing unit sections along apparatus, and defining an axis length, a motor stator for a motor driven by drilling fluids, a motor rotor for said motor driven by drilling fluid, a bent subassembly at the lower end of said downhole apparatus, said subassembly providing a relatively small angular deviation between said housing unit axis and an axis defined by said bent subassembly, an output shaft extending within said bent subassembly for use in driving a drill bit, a bearing assembly to support said output shaft for rotation within said housing, a torsion bar or flexible shaft connecting said motor rotor to said output shaft, said torsion bar or flexible shaft accommodating both eccentric motion of said rotor and the bend and relative motion between the said main housing axis and the bent subassembly axis, and a sensor and data transmission assembly located on the main housing in a parallel relationship with said torsion bar or flexible shaft, and extending generally at the same longitudinal distance along said main housing as said torsion bar or flexible shaft.

This application claims priority from provisional application Ser. No. 60/836,486, filed Aug. 8, 2006.

### BACKGROUND OF THE INVENTION

This invention relates generally to a measure while drilling apparatus used for directional drilling of boreholes in the earth. Such drilling generally includes a drilling motor, sensors for drill string or hole inclination, direction and various drilling parameters as near to the bit as feasible means for transmitting such sensor data to a location above the drilling motor, and a bent subassembly which provides the means for directional drilling.

In the prior art, drilling motors are known often to be of the “Moineau” or progressive-cavity type, operated by the flow of drilling fluids pumped down through the drill string from the surface. Such motors require coupling mechanism to couple the eccentric motion of the drill-motor rotor to the drill bit. One well-known coupling means is a flexible torsion bar as disclosed in certain prior patents, such as U.S. Pat. Nos. 5,090,497, 5,456,106 and 5,725,062. In the prior art it is also known to use sensing means for inclination, direction and other drilling parameters below the drilling motor. In U.S. Pat. No. 5,456,106 a sensor housing having an axial opening therethrough provides a pathway for the flow of the drilling fluid to the bit region. Since the sensing means are below the drilling motor, some way for short range communication is required to transmit the data to a point above the drilling motor for retransmission to the surface. Wired connections for such short range transmission are shown in U.S. Pat. No. 5,456,106 in which the wires are placed within the outer case of the drilling motor and in U.S. Pat. No. 5,725,062 wherein the wires are placed within the rotor of the drilling motor. U.S. Pat. No. 5,160,925 discloses use of a toroid core with a primary winding on the core, the drill string being located through the center of the opening. Electrical signal applied to the primary winding induce currents in the drill string components, that are detected by a similar toroid core at a higher location in the drill string above the drilling motor. U.S. Pat. No. 6,057,784 discloses a solenoid transmitting core with ferrite elements embedded in the core to enhance the launching of a magnetic field into the drilling assembly. The wind connections disclosed in such patents have not generally been adopted. Other approaches require complicated mechanical structures and a large number of parts and assemblies.

In location of the sensing means below the drilling motor causes an increase in length of the complete assembly. Such sensing means may be a separate subassembly or may be incorporated in the bent subassembly. Incorporation in the bent subassembly may shorten the overall length, but adds to the problem of not having the inclination and direction sensors correctly aligned with the longitudinal axis of the drill string.

A recent development in short range data transmission is disclosed in U.S. patent application Ser. No. 11/353,364, “Electric Field Communication for Short Range Data Transmission in a Borehole”, wherein a recessed insulated conductive element is used to inject electrical signal currents directly into a formation for detection at another nearby location in the drill string using another insulated conductive element. Experiments have shown that such direct electric injection and detection of currents can provide a very simple and effective short range communication system requiring less mechanical complexity in the drill string structure below a drilling motor. Further, the reduced size of such an apparatus permits the placement of desired sensing means and data transmission means in parallel with the motor torsion bar rather than in series with the torsion bar. This provides a significant reduction in the overall apparatus. Such parallel placement of the sensing means also permits replacement in the field of the entire sensor assembly, without major disassembly of the complete measure while drilling apparatus.

The major objective of this invention is to provide improved reduced-length measure while drilling apparatus by using an electric field short range data transmission apparatus and with the sensing and data transmission elements placed in parallel with the torsion bar of the drilling motor. It is a further objective to provide an apparatus in which the sensing and data transmission elements can be replaced without complete disassembly of the apparatus.

### SUMMARY OF THE INVENTION

The apparatus of the invention provides a downhole apparatus for measure while drilling usage and comprises:

a) a housing including one or more housing unit sections along apparatus length, and defining an axis,

b) a motor stator for a motor driven by drilling fluids,

c) a motor rotor for said motor driven by drilling fluids,

d) a bent subassembly at the lower end of said downhole apparatus, said subassembly providing a relatively small angular deviation between said housing unit axis and an axis defined by said bent subassembly,

e) an output shaft extending within said bent subassembly for use in driving a drill bit,

f) a bearing assembly to support said output shaft for retention within said housing,

g) a torsion bar or flexible shaft connecting said motor rotor to said output shaft, said torsion bar or flexible shaft accommodating both eccentric motion of said rotor and the bend and relative motion between the said main housing axis and the bent subassembly axis,

h) and a sensor and data transmission assembly located on the main housing in a parallel relationship with said torsion bar or flexible shaft, and extending generally at the same longitudinal distance along said main housing as said torsion bar or flexible shaft.

These and other objects and advantages of the invention, as well as the details of an illustrative embodiment, will be more fully understood from the following specification and drawings, in which:

### DRAWING DESCRIPTION

FIGS. 1a, 1b, and 1c illustrate a longitudinal cross-section of the apparatus of the present invention, and wherein, 1b is as extension of 1a, and 1c is an extension of 1b;

FIG. 1 is a longitudinal cross section of the apparatus of the present invention showing major components;

FIG. 2a is a cross-sectional view of sensor and data transmission means, showing the recessed insulated conductive element used to inject and/or receive currents into the formation;

FIG. 2b is a longitudinal cross section of the sensor and data transmission means showing the recessed insulated conductive element used to inject and/or receive currents into the formation.

### DETAILED DESCRIPTION

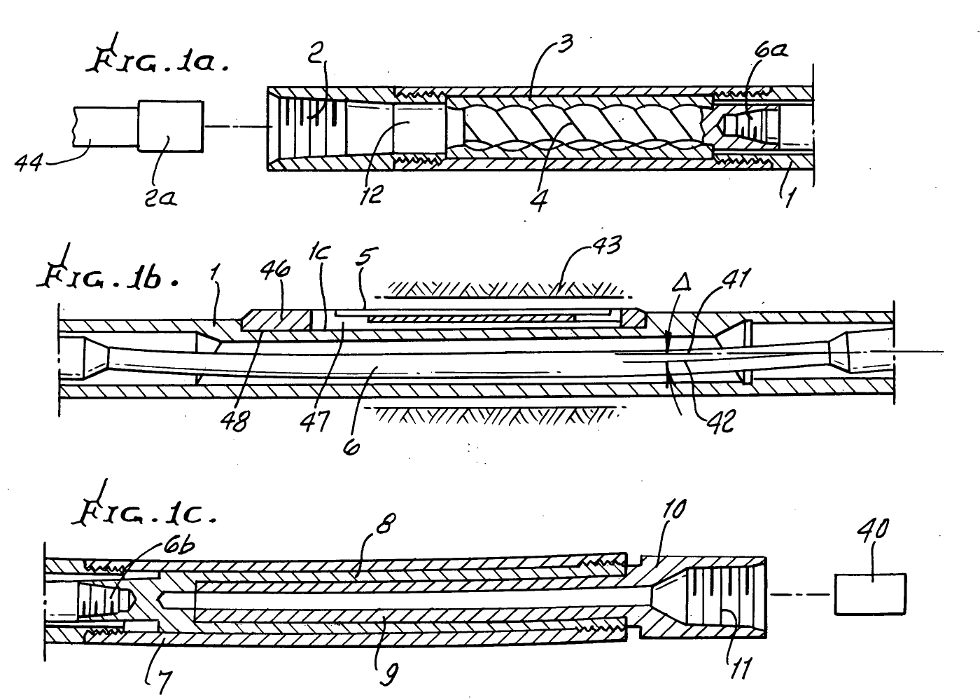

FIGS. 1a thru 1c shows a longitudinal cross section of the apparatus of the present invention, showing major components. The outer case or main housing 1, which may include multiple sections along its length, is shown to have a threaded tubular connection 2 at its upper end, for connection to other elements of a drill string above this apparatus indicated generally at 2a. A stator 3 and a rotor 4 for a “Moineau” or progressive-cavity type motor operated by the flow of drilling fluids pumped down through the drill string from the surface, are shown. A torsion bar or flexible shaft 6 is used to connect the eccentric motion of the rotor 4 to the lower elements of the apparatus. See connection 6a. The lower end of the shaft 6 is connected as at 6b to a rotary shaft 10 which drives a bit attached to the threaded connection 11 at the lower end of the apparatus. The bit diagrammatically indicated at 40. A bent subassembly 7 and 8 houses a radial and thrust bearing assembly 9 that transfers load from the bit at the lower end of the assembly, and shaft 10, to the case 8. Bending of the shaft 6 as shown accommodates both the eccentric motion of the rotor 4 and the bend angle between the axis 41 of the housing 1 and the bent axis 42 of the bent subassembly 7 and 8. As shown, axis 42 is concave toward axis 41, and convex radially away from axis 42. For suitable drilling operations the bend angle Δ between the housing axis 41 and the bent subassembly axis 42 may lie in the range of 0 to 4 degrees.

A sensor and data transmission assembly is provided at 5 adjacent case 1, and contains short range data transmission circuitry of the type shown in U.S. patent application Ser. No. 11/353,3624, “Electric Field Communication for Short Range Data Transmission in a Borehole”, wherein a recessed insulated conductive element is used to inject electrical signal currents outwardly directly into a formation 43 for detection at another nearby location in the drill string using another insulated conductive elements. The other nearby location is typically in the drill string as at 44 above this apparatus, where desired data may be transmitted on to a surface location by known transmission means. Two well known such means are by pressure pulses induced in the drilling fluid or by electrical transmission. Note particularly the parallel placement of the sensor and data transmission assembly 5 and the torsion bar or flexible shaft 6 such that no length is added to the total apparatus. Also note that the sensor and transmission assembly may be removed and replaced without any disassembly of the total apparatus. For this purpose assembly 5 may be located in a carrier 46 removably received sidewardly at 48 in a cavity 47 defined by housing section 1c.

Any selected array of sensors may be included in the sensor and data transmission assembly 5. Typically, such an array may include inclination sensors, direction sensors, formation resistivity sensors, gamma ray sensors, pressure sensors. RPM sensors, torque sensors, weight-on-bit sensors and temperature sensors. Requirements on what may be placed in the assembly 5 are fit and power requirements. A block diagram of sensor and data transmission assembly elements including elements of an upper location to communicate therewith, is shown in FIG. 5 of U.S. patent application Ser. No. 11/353,364, “Electric Field Communication for Short Range Data Transmission in a Borehole” incorporated herein by reference.

Drilling fluid enters the apparatus of the invention through the connection 2 and flows through the interior of the apparatus as at 12 and past shaft 6, to exit the apparatus into the drill bit at 40, through connection 11. Since the sensor and data transmission assembly 5 is in parallel with and located at one side of the torsion bar or flexible shaft 6, there is no need for an axial opening through the assembly 5 as is described for the sensor housing in U.S. Pat. No. 5,456,106.

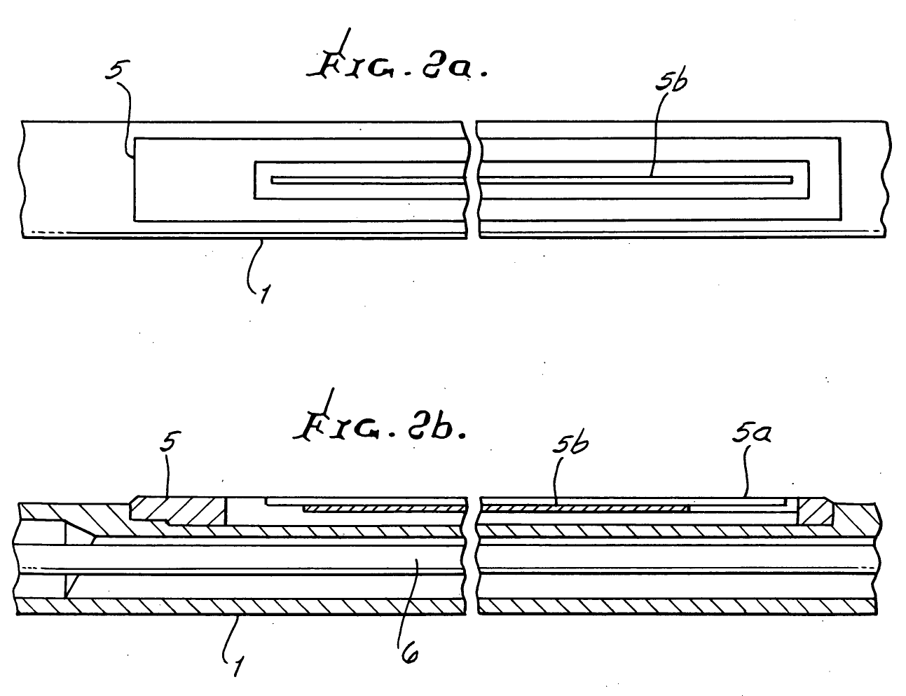

FIG. 2a is a view of the sensor and data transmission means 5 showing the recessed insulated conductive element 5b and an insulating material 5a used to inject and/or receive currents into or from the formation, or to pass electric fields. FIG. 2b is a longitudinal cross section of the sensor and data transmission means showing the same conductive element 5b and insulating material 5a.

It will be seen from the above that one or more housing units extend lengthwise generally longitudinally, said torsion bar or flexible shaft also extending generally longitudinally, and said sensor and data transmission assembly is offset laterally from the torsion bar or flexible shaft which extends within said one or more housing unit sections. Also, it will be seen that the sensor and data transmission assembly includes an insulated electrically conductive element which extends longitudinally in a position which is recessed inwardly relative to a cylinder defined by the outer surface of said one or more housing units, and is also spaced laterally from said torsion bar or flexible shaft, whereby drilling fluid is flowable therebetween. Also, the housing defines a side recess, everywhere at one side of the output shaft, and which contains said data and transmission assembly, there being a fluid flow path between said shaft and said side recess.

I claim:

1. A down hole apparatus for measure while drilling usage comprising, in combination,
a) a housing including one or more housing unit sections along apparatus, and defining an axis length,
b) a motor stator for a motor driven by drilling fluids,
c) a motor rotor for said motor driven by drilling fluid,
d) a bent subassembly at the lower end of said downhole apparatus, said subassembly providing a relatively small angular deviation between said housing unit axis and an axis defined by said bent subassembly,
e) an output shaft extending within said bent subassembly for use in driving a drill bit,
f) a bearing assembly to support said output shaft for rotation within said housing,
g) a torsion bar or flexible shaft connecting said motor rotor to said output shaft, said torsion bar or flexible shaft accommodating both eccentric motion of said rotor and the bend and relative motion between the said main housing axis and the bent subassembly axis,
h) and a sensor and data transmission assembly located on the main housing in a parallel relationship with said torsion bar or flexible shaft, and extending generally at the same longitudinal distance along said main housing as said torsion bar or flexible shaft.

2. The apparatus of claim 1 wherein the said sensor and data transmission assembly is of the electric field communication type for short range data communication in a borehole.

3. The apparatus of claim 2 wherein the said sensor and data transmission assembly of the electric field communication type is further characterized as including a recessed insulated conductive element and an insulating material used to inject and/or receive currents into or from the formation, at one side of the output.

4. The apparatus of claim 1 wherein said sensor and data transmission assembly includes inclination sensors.

5. The apparatus of claim 1 wherein said sensor and data transmission assembly includes direction sensors.

6. The apparatus of claim 1 wherein said sensor and data transmission assembly includes formation evaluation sensors.

7. The apparatus of claim 6 wherein said formation evaluation sensors include formation resistivity sensors.

8. The apparatus of claim 6 wherein said formation evaluation sensors include gamma ray sensors.

9. The apparatus of claim 1 wherein said one or more housing units extend lengthwise generally longitudinally, said torsion bar or flexible shaft also extending generally longitudinally, and said sensor and data transmission assembly is offset laterally from the torsion bar or flexible shaft which extends within said one or more housing unit sections.

10. The apparatus of claim 9 wherein said sensor and data transmission assembly includes an insulated electrically conductive element which extends longitudinally in a position which is recessed inwardly relative to a cylinder defined by the outer surface of said one or more housing units, and is also spaced laterally from said torsion bar or flexible shaft, whereby drilling fluid is flowable therebetween.

11. The apparatus of claim 10 wherein the housing defines a side recess everywhere at one side of the output shaft, and which contains said data and transmission assembly, there being a fluid flow path between said shaft and said side recess.

12. In a well downhole drilling apparatus operable or measure while drilling,
a) longitudinally extending housing means,
b) means including a torsion bar or flexible shaft extending lengthwise within said housing means for transmitting rotation to a drilling bit in response to drilling fluid flow lengthwise through said housing means,
c) and a sensor and data transmission means carried by said housing means in laterally offset relation to said torsion bar or flexible shaft whereby drilling fluid is flowable through said housing means between said torsion bar or flexible shaft and said sensor and data transmission means.

13. The apparatus of claim 12 wherein said sensor and data transmission means includes a laterally facing insulated electrically conductive element which extends generally longitudinally in a position which is recessed inwardly relative to a cylinder defined by the outer surface of said housing means, and is also spaced laterally from said torsion bar or flexible shaft to accommodate drilling fluid flow generally longitudinally past the torsion bar.
